(19) United States
(12) Patent Application Publication
(10) Pub. No.: US 2025/0337252 A1
(43) Pub. Date: Oct. 30, 2025

(54) Expansion Type Output Control System with Easy Node Change Based on Triangular Connection Structure for Quick Charger for Multi-Channel Output

(71) Applicant: EGTRONICS Co., Ltd., Hwaseong-Si (KR)

(72) Inventors: Chan-Ho Kang, Hwaseong-Si (KR); Young-Gun Hong, Goyang-Si (KR); Ui-Soung Park, Daejeon (KR); Ko Choi, Seoul (KR); Su-Kang Lee, Incheon (KR)

(21) Appl. No.: 18/648,275

(22) Filed: Apr. 26, 2024

(51) Int. Cl. H02J 7/00

(52) U.S. Cl. CPC H02J 7/0013; H02J 7/0047; H02J 7/00712

(57) ABSTRACT

The present disclosure relates to an expansion type output control system with easy node change based on a triangular connection structure capable of easy dispersive expansion which can reduce design cost through forming a multi-channel charging system based on a relatively simple triangular structure, comprises first to n-th (n is a natural number greater than or equal to 2) triangular connections each comprising 3 power supply power modules connected to each other with the relay; and p output terminals (p is a natural number greater than or equal to 4) connected to the first to n-th triangular connections, wherein the first to n-th triangular connections are connected to each other.

### CROSS-REFERENCE TO RELATED APPLICATION(S)

This application is based on and claims priority of Korean Patent Application No. 10-2023-0056272, filed on Apr. 28, 2023 with the Korean Intellectual Property Office, the entire contents of which are hereby incorporated by reference.

### TECHNICAL FIELD

The present disclosure relates to an expansion type output control system with easy node change based on triangular connection structure. More specifically, the present disclosure relates to an expansion type output control system with easy node change based on triangular connection structure for quick charger (DC charger) for multi-channel output.

### BACKGROUND

In the wake of global environmental regulations and high oil prices, the development and distribution of eco-friendly and low-cost electric vehicles are expanding globally to save energy. Further, various technologies are being developed for charging batteries of electric vehicles and for expanding charging stations. These charging systems may consist of multi-channel charging systems comprising multiple power modules.

FIG. 1 shows an example 5-channel charging system.

As shown in FIG. 1, the 5-channel charging system may include five power modules (indicated as P/Mn (n is a natural number 1 to 8) in FIG. 1), and in this case, ten relays are required connect between each power module. However, in case of the multi-channel charging system, since a relatively large number of relays were required, installation costs is increased, the control algorithm becomes complicated, and expansion is not easy.

### SUMMARY

The present disclosure is devised to solve the problems described above, and the object of an expansion type output control system with easy node change based on triangular connection structure for quick charger (DC charger) for multi-channel output according to the present disclosure is to provide an expansion type output control system with easy node change based on triangular connection structure for quick charger (DC charger) for multi-channel output, with a multi-channel charging system based on a relatively simple triangular structure, capable of easy dispersive expansion which can reduce the design cost.

The expansion type output control system with easy node change based on triangular connection structure for quick charger (DC charger) for multi-channel output according to the present disclosure for achieving the above technical objects comprises first to n-th (n is a natural number greater than or equal to 2) triangular connections each comprising 3 power supply power modules connected to each other with the relay; and p output terminals (p is a natural number greater than or equal to 4) connected to the first to n-th triangular connections, wherein the first to n-th triangular connections are connected to each other.

Further, at least two of the first to n-th triangular connections share one power module with each other and constitute the p output terminals.

Further, the k-th triangular connection (k is a natural number greater than or equal to 1 and less than or equal to n) comprises a (k-1)th power module, a (k-2)th power module, and a (k-3)th power module connected to each other with the relay, the p is 4 and the n is 2, the (1-2)th power module is identical to the (2-2)th power module, and the (1-3)th power module is identical to the (2-3)th power module.

Further, the k-th triangular connection (k is a natural number greater than or equal to 1 and less than or equal to n) comprises a (k-1)th power module, a (k-2)th power module, and a (k-3)th power module connected to each other with relays, the p is 5 and the n is 2, and the (1-3)th power module is identical to the (2-3)th power module.

Further, the k-th triangular connection (k is a natural number greater than or equal to 1 and less than or equal to n) comprises a (k-1)th power module, a (k-2)th power module, and a (k-3)th power module connected to each other with the relay, the p is 7 and the n is 3, and the (1-3)th power module is identical to the (2-3)th power module and the (3-3)th power module.

Further, the k-th triangular connection (k is a natural number greater than or equal to 1 and less than or equal to n) comprises a (k-1)th power module, a (k-2)th power module, and a (k-3)th power module connected to each other with the relay, the p is 8 and the n is 4, the (1-2)th power module is identical to the (2-2)th power module and the (3-2)th power module, and the (1-3)th power module is identical to the (2-3)th power module and the (4-3)th power module.

Further, the k-th triangular connection (k is a natural number greater than or equal to 1 and less than or equal to n) comprises a (k-1)th power module, a (k-2)th power module, and a (k-3)th power module connected to each other with the relay, the p is 9 and the n is 4, and the (1-2)th power module is identical to the (2-2)th power module, the (3-2)th power module, and the (4-2)th power module.

Further, the k-th triangular connection (k is a natural number greater than or equal to 1 and less than or equal to n) comprises a (k-1)th power module, a (k-2)th power module, and a (k-3)th power module connected to each other with the relay, the p is 10 and the n is 6, the (1-2)th power module is identical to the (2-2)th power module and the (3-2)th power module, the (1-3)th power module is identical to the (2-3)th power module and the (4-3)th power module, the (3-1)th power module is identical to the (5-1)th power module, the (3-2)th power module is identical to the (5-2)th power module, the (4-1)th power module is identical to the (6-1)th power module, and the (4-2)th power module is identical to the (6-2)th power module.

Further, the k-th triangular connection (k is a natural number greater than or equal to 1 and less than or equal to n) comprises a (k-1)th power module, a (k-2)th power module, and a (k-3)th power module connected to each other with the relay, the p is 6 and the n is 2, and the (1-3)th power module and the (2-3)th power module are connected to each other with a relay.

The expansion type output control system with easy node change based on triangular connection structure for quick charger (DC charger) for multi-channel output according to one embodiment of the present disclosure is configured to implement a multi-channel charging system using at least two triangular connections so it has a relatively simple structure and is easily expandable. Further, the system according to one embodiment shares and expands at least one power module, thereby implementing the multi-channel charging system using a minimum number of relays.

### BRIEF DESCRIPTION OF THE DRAWINGS

FIG. 1 shows an example 5-channel charging system.

FIG. 2A is a triangular connection structure for an expansion type output control system with easy node change based on triangular connection structure for quick charger (DC charger) for multi-channel output of the present disclosure.

FIG. 2B is a schematic circuit diagram with the triangular connection of FIG. 2A applied.

FIG. 3A is a triangular connection of the multi-channel charging system according to the first embodiment of the present disclosure.

FIG. 3B is a schematic circuit diagram with the triangular connection of FIG. 3A applied.

FIG. 4A is a triangular connection of the multi-channel charging system according to the second embodiment of the present disclosure.

FIG. 4B is a schematic circuit diagram with the triangular connection of FIG. 4A applied.

FIG. 5A is a schematic circuit diagram of a 5-channel charging system using a matrix structure.

FIG. 5B is a schematic circuit diagram of a 5-channel charging system using a mesh structure.

FIG. 6A is a triangular connection of the multi-channel charging system according to the third embodiment of the present disclosure.

FIG. 6B is a schematic circuit diagram with the triangular connection of FIG. 6A applied.

FIG. 7A is a triangular connection of the multi-channel charging system according to the fourth embodiment of the present disclosure.

FIG. 7B is a schematic circuit diagram with the triangular connection of FIG. 7A applied.

FIG. 8A is a triangular connection of the multi-channel charging system according to the fifth embodiment of the present disclosure.

FIG. 8B is a schematic circuit diagram with the triangular connection of FIG. 8A applied.

FIG. 9A is a schematic circuit diagram of a 8-channel charging system using a general structure.

FIG. 9B is a schematic circuit diagram of a 8-channel charging system using a matrix structure.

FIG. 9C is a schematic circuit diagram of a 8-channel charging system using a mesh structure.

FIG. 10 is a triangular connection of the multi-channel charging system according to the sixth embodiment of the present disclosure.

FIG. 11 is a triangular connection of the multi-channel charging system according to the seventh embodiment of the present disclosure.

### DETAILED DESCRIPTION OF EXEMPLARY EMBODIMENTS

The object, features, and advantages of the present disclosure will become more apparent with the following embodiments related to the attached drawings. The following specific structural or functional descriptions are exemplified for the purpose of illustrating embodiments in accordance with the concepts of the present disclosure only, and embodiments in accordance with the concepts of the present disclosure may be implemented in various forms and should not be construed as limiting to the embodiments described herein or in the application. Since the embodiments according to the concepts of the present disclosure are subject to various modifications and may take many forms, certain embodiments are to be illustrated in the drawings and described in detail in the present specification or application. However, this is not intended to limit the embodiments according to the concepts of the present disclosure to any particular disclosed form, and is to be understood to include all modifications, equivalents, or substitutions that fall within the scope of the ideas and techniques of the present disclosure. Terms such as first and/or second may be used to describe various components, but the components are not limited to the terms. The above terms are used solely for the purpose of distinguishing one component from another, e.g. a first component may be named a second component, and similarly a second component may be named a first component, without departing from the scope of the rights in accordance with the concept of the disclosure. When a component is referred to as coupled to or connected to another component, it should be understood that it may be directly coupled to or connected to that other component, but there may be other components in between. On the other hand, when a component is said to be directly coupled to or connected to another component, it should be understood that there is no other component in between. Other expressions to describe the relationship between components, such as between ˜ and directly between ˜ or adjacent to ˜ and directly adjacent to ˜, should be interpreted similarly. The terms used herein is intended to describe particular embodiments only and is not intended to limit the present disclosure. Singular expressions include plural expressions unless context clearly indicates otherwise. Terms used in the present disclosure such as include or comprise are intended to designate the presence of the features, numbers, steps, operations, components, parts, or combinations thereof described, and are not intended to preclude the presence or addition of one or more other features, numbers, steps, operations, components, parts, or combinations thereof. Unless otherwise defined, all terms used herein, including technical or scientific terms, have the same meaning as commonly understood by a person of ordinary skill in the technical field to which the present disclosure belongs. Terms such as those defined in commonly used dictionaries shall be construed to have meanings consistent with their meaning in the context of the relevant art and shall not be construed to have an idealized or unduly formal meaning unless expressly defined in this specification. Hereinafter, the present disclosure will be described in detail by describing the preferred embodiments of the present disclosure with reference to the attached drawings. The same reference numerals shown in each drawing refer to the same elements.

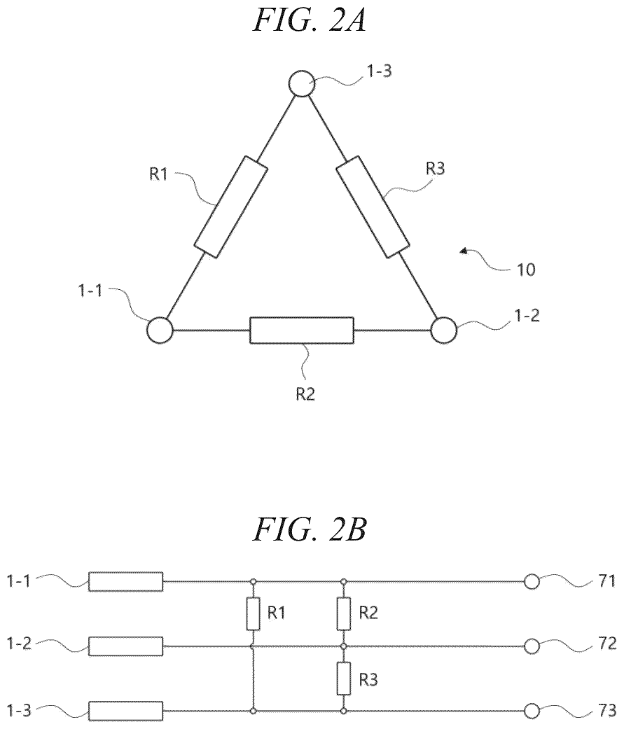

FIG. 2A is a triangular connection structure for an expansion type output control system with easy node change based on triangular connection structure for quick charger (DC charger) for multi-channel output of the present disclosure, and FIG. 2B is a schematic circuit diagram of the triangular connection of FIG. 2A applied.

The triangular connection shown in FIGS. 2A is referred to as first triangular connection 10, and the first triangular connection 10 may include a (1-1)th power module 1-1, a (1-2)th power module 1-2, and a (1-3)th power module 1-3. Each of the (1-1)th power module 1-1, (1-2)th power module 1-2, and (1-3)th power module 1-3 has an individual output terminal, and the individual output terminal becomes a charging channel in the multi-channel charging system of the present disclosure. The output terminals shown in FIG. 2B are referred to as a first output terminal 71, second output terminal 72, and third output terminal 73, respectively. Each of the (1-1)th power module 1-1, (1-2)th power module 1-2, and (1-3)th power module 1-3 is connected to each other with a relay, and a total of three relays are included in one triangular connection. A power module is a part that outputs power, and the number of channels is determined according to the number of power modules.

The main technical feature of expansion type output control system with easy node change based on triangular connection structure for quick charger (DC charger) for multi-channel output according to various embodiments of the present disclosure is to reduce the number of relays required to form a multi-channel charging system by sharing or connecting two or more triangular connections to each other. Hereinafter, various embodiments of the present disclosure will be described.

### First Embodiment—4-Channel Charging System

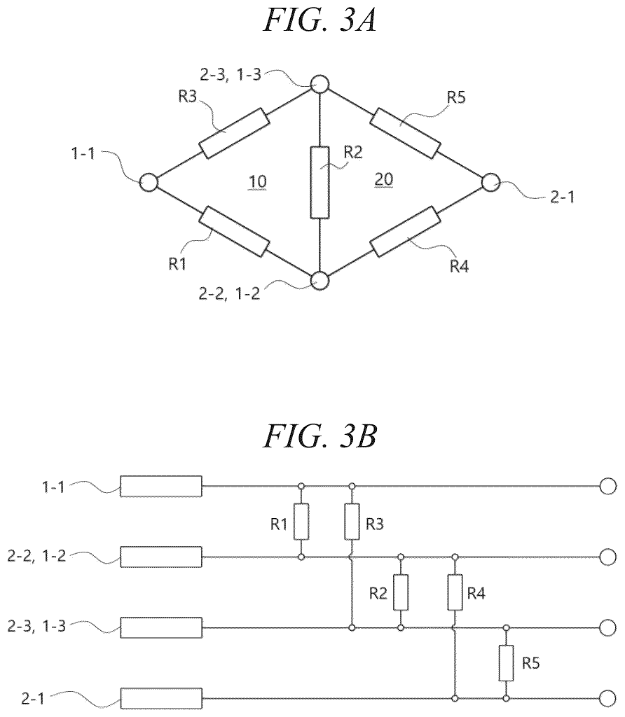

FIG. 3A is a triangular connection of a multi-channel charging system according to the first embodiment of the present disclosure, and FIG. 3B is a schematic circuit diagram with the triangular connection of FIG. 3A applied.

As shown in FIGS. 3A and 3B, the multi-channel charging system according to the first embodiment of the present disclosure is a 4-channel charging system. In this case, the present embodiment may include a first triangular connection 10 and a second triangular connection 20.

The first triangular connection 10 may include a (1-1)th power module 1-1, a (1-2)th power module 1-2 and a (1-3)th power module 1-3, and the second triangular connection 20 may include a (2-1)th power module 2-1, a (2-2)th power module 2-2 and a (2-3)th power module 2-3. Here, the (1-2)th power module 1-2 and the (2-2)th power module 2-2 are identical, and the (1-3)th power module 1-3 and the (2-3)th power module 2-3 are identical to each other. At this time, ‘identical’ may be understood as ‘shared’. The power modules in the first triangular connection 10 are connected to each other by relays, and the power modules in the second triangular connection 20 are also connected to each other by relays. In the present embodiment, since the first triangular connection 10 and the second triangular connection 20 share some power modules, the number of relays connecting each power modules to each other (five in total) may be reduced compared to before, and the relays are referred to as first to fifth relays R1, R2, R3, R4, and R5. With the above configuration, the present embodiment allows for a relatively economical installation of the 4-channel charging system, and also has the effect of simplifying the operation algorithm through a simple structure.

### Second Embodiment—5-Channel Charging System

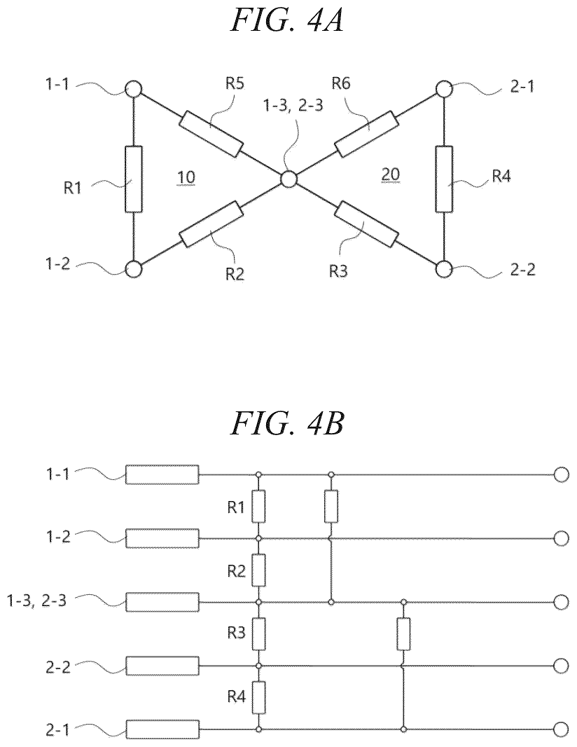

FIG. 4A is a triangular connection of a multi-channel charging system according to the second embodiment of the present disclosure, and FIG. 4B is a schematic circuit diagram with the triangular connection of FIG. 4A applied.

As illustrated in FIGS. 4A and 4B, the multi-channel charging system according to the second embodiment of the present disclosure is a 5-channel charging system, and in this case, the present embodiment may include a first triangular connection 10 and a second triangular connection 20.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3. Here, the (1-3)th power module 1-3 and the (2-3)th power module 2-3 are identical to each other. Accordingly, a total number of six relays, first to sixth relays R1, R2, R3, R4, R5, and R6 are required to connect each power module.

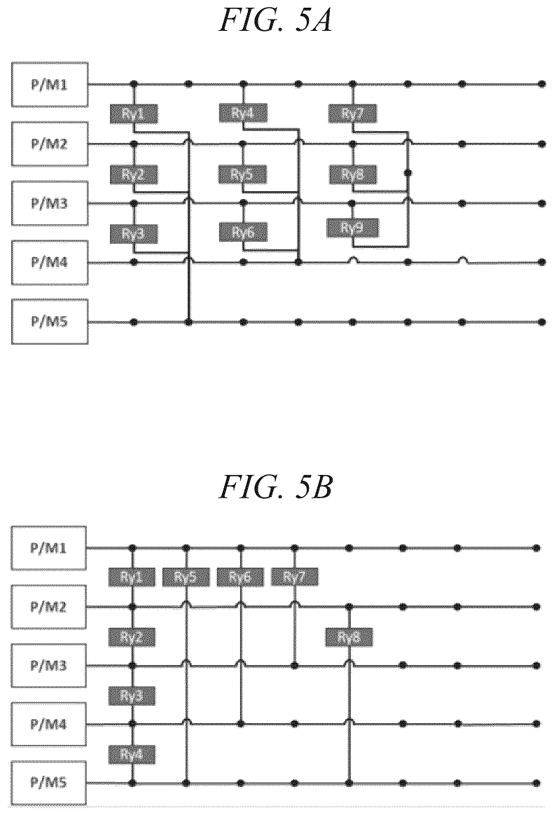

FIG. 5A is a schematic circuit diagram of a 5-channel charging system using a matrix structure, and FIG. 5B is a schematic circuit diagram of a 5-channel charging system using a mesh structure.

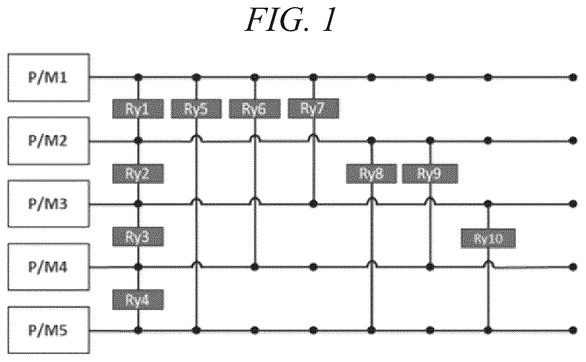

The number of relays required in a 5-channel charging system using the general structure shown in FIG. 1 is ten. However as shown in FIG. 5A, the number of relays required in the 5-channel charging system using a matrix structure is nine, and as shown in FIG. 5B, the number of relays required in the 5-channel charging system using a mesh structure is eight. That is, compared to the conventional 5-channel charging system using a general structure, matrix structure, and mesh structure, the 5-channel charging system according to the present embodiment can be configured using only six relays, allowing for a more economical implementation of the 5-channel charging system.

### Third Embodiment—6-Channel Charging System

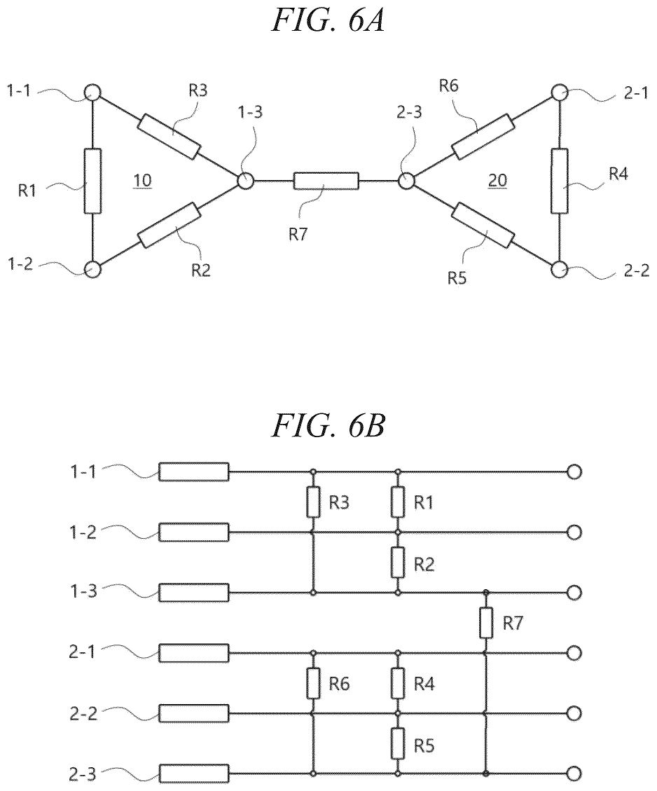

FIG. 6A is a triangular connection of a multi-channel charging system according to the third embodiment of the present disclosure, and FIG. 6B is a schematic circuit diagram with the triangular connection of FIG. 6A applied.

As illustrated in FIGS. 6A and 6B, the multi-channel charging system according to the third embodiment of the present disclosure is a 6-channel charging system. In this case, the present embodiment may include a first triangular connection 10 and a second triangular connection 20.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3.

In the present embodiment, unlike the first and second embodiments described above, the first triangular connection 10 and the second triangular connection 20 do not share a power module, but the (1-3)th power module 1-3 and the (2-3)th power module 2-3 are connected to each other through a relay. Therefore, the present embodiment may include a total of seven relays, which are first to seventh relays R1, R2, R3, R4, R5, R6, and R7. In the present embodiment, a plurality of triangular connections does not share at least one power module, but when checking the number of relays, the number of relays according to the present embodiment is one less than the number (eight) of relays the 5-channel charging system having the mesh structure illustrated in FIG. 5B. Therefore, the expansion type output control system with easy node change based on triangular connection structure for quick charger (DC charger) for multi-channel output according to the present disclosure has the effect of simplifying the multi-channel charging system itself by reducing the number of relays.

### Fourth Embodiment—7-Channel Charging System

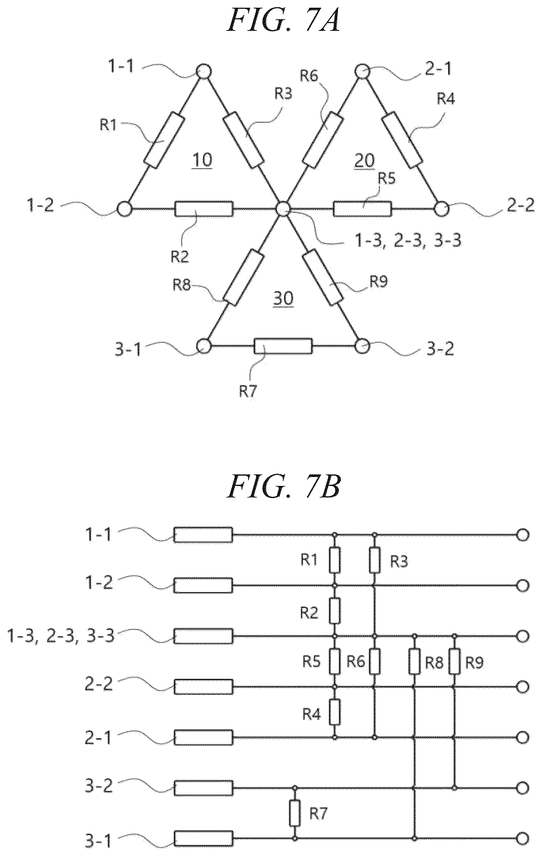

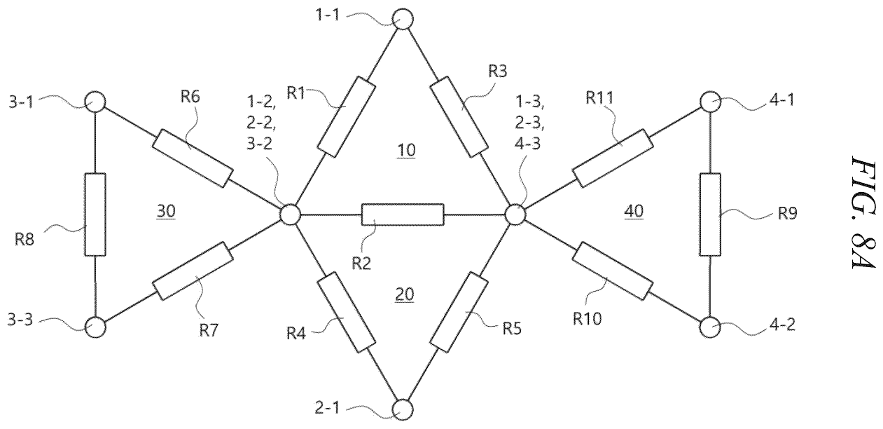

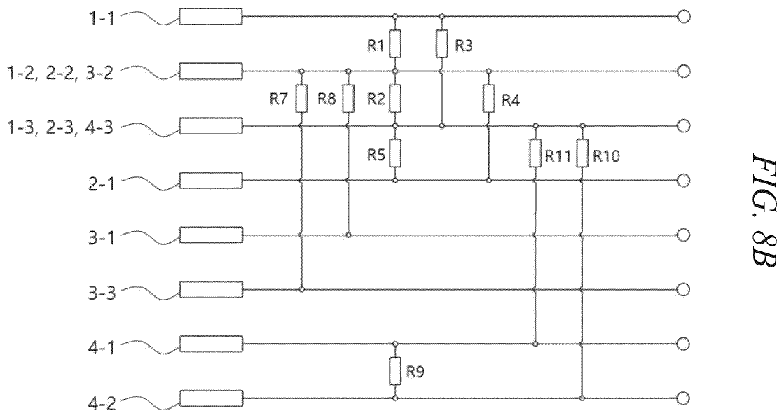

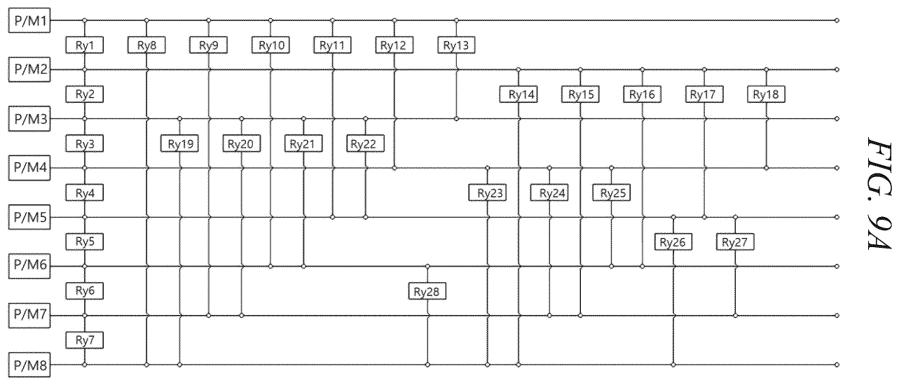

FIG. 7A is a triangular connection of a multi-channel charging system according to the fourth embodiment of the present disclosure, and FIG. 7B is a schematic circuit diagram with the triangular connection of FIG. 7A applied.

As shown in FIGS. 7A and 7B, the multi-channel charging system according to the fourth embodiment of the present disclosure is a 7-channel charging system. In this case, the present embodiment may include first to third triangular connections 10, 20, and 30.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3. The third triangular connection 30 may include a (3-1)th power module 3-1, a (3-2)th power module 3-2, and a (3-3)th power module 3-3.

The present embodiment is similar to the multi-channel charging system of the second embodiment of the present disclosure described earlier, wherein the (3-3)th power module 3-3 included in the third triangular connection 30 is identical to the (1-3)th power module 1-3 and the (2-3)th power module 2-3. That is, as shown in FIGS. 7A and 7B, the first to third triangular connections 10, 20, and 30, are connected to each other through sharing a power module disposed on one node. The present embodiment shown in FIGS. 7A and 7B illustrates how easily it can be expanded to a charging system including multiple channels based on triangular connections.

### Fifth Embodiment—8-Channel Charging System

FIG. 8A is a triangular connection of a multi-channel charging system according to the fifth embodiment of the present disclosure, and FIG. 8B is a schematic circuit diagram with the triangular connection of FIG. 8A applied.

As shown in FIGS. 8A and 8B, the multi-channel charging system according to the fifth embodiment of the present disclosure is an 8-channel charging system. In this case, the present embodiment may include first to fourth triangular connections 10, 20, 30, and 40.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3. The third triangular connection 30 may include a (3-1)th power module 3-1, a (3-2)th power module 3-2, and a (3-3)th power module 3-3. The fourth triangular connection 40 may include a (4-1)th power module 4-1, a (4-2)th power module 4-2, and a (4-3)th power module 4-3.

The present embodiment is similar to the multi-channel charging system of the first and/or second embodiment of the present disclosure described earlier, wherein the (3-2)th power module 3-2 of the third triangular connection 30 is identical to the (1-2)th power module 1-2 and the (2-2)th power module 2-2, and the (4-3)th power module 4-3 of the fourth triangular connection 40 is identical to the (1-3)th power module 1-3 and the (2-3)th power module 2-3.

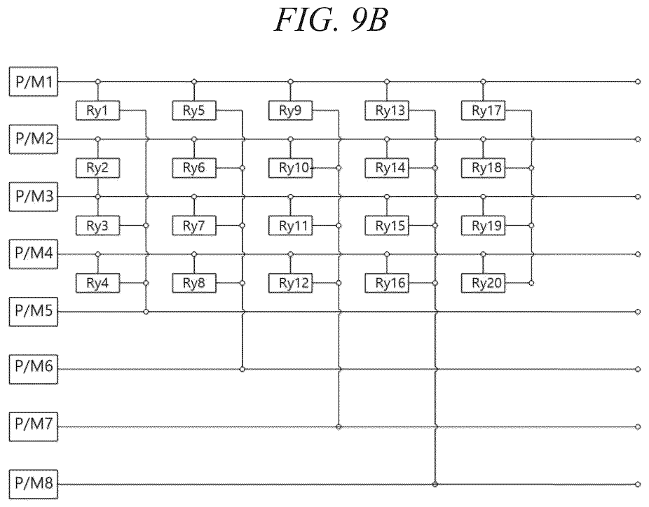

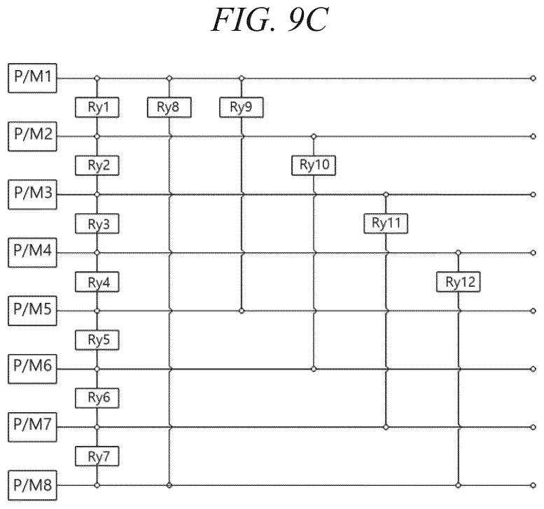

FIG. 9A is a schematic circuit diagram of an 8-channel charging system using a general structure, FIG. 9B is a schematic circuit diagram of an 8-channel charging system using a matrix structure, and FIG. 9C is a schematic circuit diagram of an 8-channel charging system using a mesh structure.

As shown in FIG. 9A, the number of relays required for the 8-channel charging system using a general structure is 28. As shown in FIG. 9B, the number of relays required for the 8-channel charging system using a matrix structure is 20. As shown in FIG. 9C, the number of relays required for the 8-channel charging system using a mesh structure is 12. That is, compared to the conventional 8-channel charging system using a general structure, matrix structure, and mesh structure, the 8-channel charging system according to the present embodiment can be configured using only 11 relays, allowing for a more economical implementation of the 8-channel charging system.

### Sixth Embodiment—9-Channel Charging System

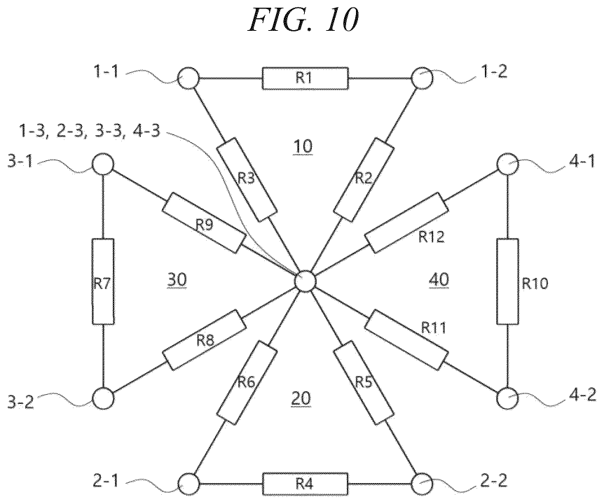

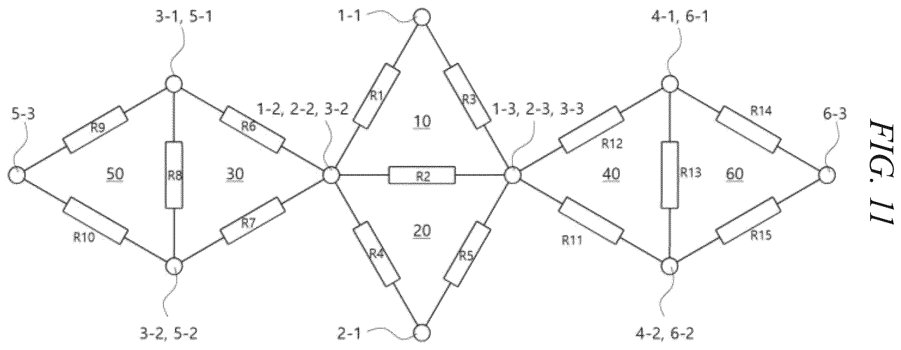

FIG. 10 is a triangular connection of a multi-channel charging system according to the sixth embodiment of the present disclosure.

As shown in FIG. 10, the multi-channel charging system according to the sixth embodiment of the present disclosure is a 9-channel charging system. In this case, the present embodiment may include first to fourth triangular connections 10, 20, 30, and 40.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3. The third triangular connection 30 may include a (3-1)th power module 3-1, a (3-2)th power module 3-2, and a (3-3)th power module 3-3. The fourth triangular connection 40 may include a (4-1)th power module 4-1, a (4-2)th power module 4-2, and a (4-3)th power module 4-3.

The present embodiment is similar to the multi-channel charging system of the first embodiment of the present disclosure described earlier, wherein the (4-3)th power module 4-3 included in the fourth triangular connection 40 is identical to the (1-3)th power module 1-3, the (2-3)th power module 2-3, and the (3-3)th power module 3-3. That is, as shown in FIGS. 8A and 8B, the first to fourth triangular connections 10, 20, 30, and 40 are connected to each other through one node.

### Seventh Embodiment—10-Channel Charging System

FIG. 11 is a triangular connection of a multi-channel charging system according to the seventh embodiment of the present disclosure.

As shown in FIG. 11, the multi-channel charging system according to the seventh embodiment of the present disclosure is a 10-channel charging system. In this case, the present embodiment may include first to fourth triangular connections 10, 20, 30, 40, 50, and 60.

The first triangular connection 10 may include a (1-1)th power module 1-1, a (1-2)th power module 1-2, and a (1-3)th power module 1-3. The second triangular connection 20 may include a (2-1)th power module 2-1, a (2-2)th power module 2-2, and a (2-3)th power module 2-3. The third triangular connection 30 may include a (3-1)th power module 3-1, a (3-2)th power module 3-2, and a (3-3)th power module 3-3. The fourth triangular connection 40 may include a (4-1)th power module 4-1, a (4-2)th power module 4-2, and a (4-3)th power module 4-3. The fifth triangular connection 50 may include a (5-1)th power module 5-1, a (5-2)th power module 5-2, and a (5-3)th power module 5-3. The sixth triangular connection 60 may include a (6-1)th power module 6-1, a (6-2)th power module 6-2, and a (6-3)th power module 6-3.

The present embodiment is similar to the multi-channel charging system of the first embodiment of the present disclosure described earlier, wherein the (5-1)th power module 5-1 of the fifth triangular connection 50 is identical to the (3-1)th power module 3-1, and the (5-2)th power module 5-2 is identical to the (3-2)th power module 3-2. Also, the (6-1)th power module 6-1 of the sixth triangular connection 60 is identical to the (4-1)th power module 4-1, and the (6-2)th power module 6-2 is identical to the (4-2)th power module 4-2.

The triangular connections may share one power module through one node or two power modules with another adjacent triangular connection, so that the expansion type output control system with easy node change based on triangular connection structure for quick charger (DC charger) for multi-channel output according to various embodiments as described above is easily expandable and has the effect of being able to form a multi-channel charging system with a relatively small number of relays.

While preferred embodiments of the present disclosure have been described above, the embodiments disclosed herein are intended to illustrate and not to limit the technical ideas of the present disclosure.

The following is a list of embodiments of the present disclosure.

Item 1 is an expansion type output control system with easy node change based on triangular connection structure comprising first to n-th (n is a natural number greater than or equal to 2) triangular connections each comprising 3 power supply power modules connected to each other with the relay and p output terminals (p is a natural number greater than or equal to 4) connected to the first to n-th triangular connections, wherein the first to n-th triangular connections are connected to each other.

Item 2 is the system of item 1, wherein at least two of the first to n-th triangular connections share one power module with each other and constitute the p output terminals.

Item 3 is the system of items 1 and 2, wherein the k-th triangular connection (k is a natural number greater than or equal to 1 and less than or equal to n) comprises a (k-1)th power module, a (k-2)th power module, and a (k-3)th power module connected to each other with the relay, the p is 4 and the n is 2, the (1-2)th power module is identical to the (2-2)th power module, and the (1-3)th power module is identical to the (2-3)th power module.

Item 4 is the system of items 1 to 3, wherein the k-th triangular connection (k is a natural number greater than or equal to 1 and less than or equal to n) comprises a (k-1)th power module, a (k-2)th power module, and a (k-3)th power module connected to each other with relays, the p is 5 and the n is 2, and the (1-3)th power module is identical to the (2-3)th power module.

Item 5 is the system of items 1 to 4, wherein the k-th triangular connection (k is a natural number greater than or equal to 1 and less than or equal to n) comprises a (k-1)th power module, a (k-2)th power module, and a (k-3)th power module connected to each other with the relay, the p is 7 and the n is 3, and the (1-3)th power module is identical to the (2-3)th power module and the (3-3)th power module.

Item 6 is the system of items 1 to 5, wherein the k-th triangular connection (k is a natural number greater than or equal to 1 and less than or equal to n) comprises a (k-1)th power module, a (k-2)th power module, and a (k-3)th power module connected to each other with the relay, the p is 8 and the n is 4, the (1-2)th power module is identical to the (2-2)th power module and the (3-2)th power module, and the (1-3)th power module is identical to the (2-3)th power module and the (4-3)th power module.

Item 7 is the system of items 1 to 6, wherein the k-th triangular connection (k is a natural number greater than or equal to 1 and less than or equal to n) comprises a (k-1)th power module, a (k-2)th power module, and a (k-3)th power module connected to each other with the relay, the p is 9 and the n is 4, and the (1-2)th power module is identical to the (2-2)th power module, the (3-2)th power module, and the (4-2)th power module.

Item 8 is the system of items 1 to 7, wherein the k-th triangular connection (k is a natural number greater than or equal to 1 and less than or equal to n) comprises a (k-1)th power module, a (k-2)th power module, and a (k-3)th power module connected to each other with the relay, the p is 10 and the n is 6, the (1-2)th power module is identical to the (2-2)th power module and the (3-2)th power module, the (1-3)th power module is identical to the (2-3)th power module and the (4-3)th power module, the (3-1)th power module is identical to the (5-1)th power module, the (3-2)th power module is identical to the (5-2)th power module, the (4-1)th power module is identical to the (6-1)th power module, and the (4-2)th power module is identical to the (6-2)th power module.

Item 9 is the system of items 1 to 8, wherein the k-th triangular connection (k is a natural number greater than or equal to 1 and less than or equal to n) comprises a (k-1)th power module, a (k-2)th power module, and a (k-3)th power module connected to each other with the relay, the p is 6 and the n is 2, and the (1-3)th power module and the (2-3)th power module are connected to each other with a relay.

Therefore, the technical idea of the present disclosure includes not only each disclosed embodiment, but also a combination of the disclosed embodiments, and furthermore, the scope of the technical idea of the present disclosure is not limited by these embodiments. Further, those skilled in the art to which the present disclosure belongs may make many changes and modifications to the disclosure without departing from the spirit and scope of the appended claims, and all such appropriate changes and modifications should be considered as equivalents and as falling within the scope of the invention.

What is claimed is:

1. An expansion type output control system comprising:
a relay;
a plurality of triangular connections, wherein each triangular connection of the plurality of triangular connections comprises three power supply power modules connected to each other with the relay, and wherein the plurality of triangular connections comprises 1st to n-th triangular connections, where n is an integer greater than or equal to two; and
a plurality of output terminals connected to the plurality of triangular connections, wherein p is a quantity of the plurality of output terminals that is greater than or equal to four,
wherein the plurality of triangular connections are connected to each other.

2. The expansion type output control system of claim 1,
wherein at least two of the 1st to n-th triangular connections share one power module with each other and constitute the plurality of output terminals.

3. The expansion type output control system of claim 2,
wherein the k-th triangular connection comprises
a (k-1)th power module, a (k-2)th power module, and a (k-3)th power module connected to each other with the relay, where k is a natural number greater than or equal to 1 and less than or equal to n,
the p is 4 and the n is 2,
the (1-2)th power module is identical to the (2-2)th power module, and
the (1-3)th power module is identical to the (2-3)th power module.

4. The expansion type output control system of claim 2,
wherein the k-th triangular connection comprises
a (k-1)th power module, a (k-2)th power module, and a (k-3)th power module connected to each other with relays, where k is a natural number greater than or equal to 1 and less than or equal to n,
the p is 5 and the n is 2, and
the (1-3)th power module is identical to the (2-3)th power module.

5. The expansion type output control system of claim 2,
wherein the k-th triangular connection comprises
a (k-1)th power module, a (k-2)th power module, and a (k-3)th power module connected to each other with the relay, where k is a natural number greater than or equal to 1 and less than or equal to n,
the p is 7 and the n is 3, and
the (1-3)th power module is identical to the (2-3)th power module and the (3-3)th power module.

6. The expansion type output control system of claim 2,
wherein the k-th triangular connection comprises
a (k-1)th power module, a (k-2)th power module, and a (k-3)th power module connected to each other with the relay, where k is a natural number greater than or equal to 1 and less than or equal to n,
the p is 8 and the n is 4,
the (1-2)th power module is identical to the (2-2)th power module and the (3-2)th power module, and
the (1-3)th power module is identical to the (2-3)th power module and the (4-3)th power module.

7. The expansion type output control system of claim 2,
wherein the k-th triangular connection comprises
a (k-1)th power module, a (k-2)th power module, and a (k-3)th power module connected to each other with the relay, where k is a natural number greater than or equal to 1 and less than or equal to n,
the p is 9 and the n is 4, and
the (1-2)th power module is identical to the (2-2)th power module, the (3-2)th power module, and the (4-2)th power module.

8. The expansion type output control system of claim 2,
wherein the k-th triangular connection comprises
a (k-1)th power module, a (k-2)th power module, and a (k-3)th power module connected to each other with the relay, where k is a natural number greater than or equal to 1 and less than or equal to n,
the p is 10 and the n is 6,
the (1-2)th power module is identical to the (2-2)th power module and the (3-2)th power module,
the (1-3)th power module is identical to the (2-3)th power module and the (4-3)th power module,
the (3-1)th power module is identical to the (5-1)th power module,
the (3-2)th power module is identical to the (5-2)th power module,
the (4-1)th power module is identical to the (6-1)th power module, and
the (4-2)th power module is identical to the (6-2)th power module.

9. The expansion type output control system of claim 1,
wherein the k-th triangular connection comprises
a (k-1)th power module, a (k-2)th power module, and a (k-3)th power module connected to each other with the relay, where k is a natural number greater than or equal to 1 and less than or equal to n,
the p is 6 and the n is 2, and
the (1-3)th power module and the (2-3)th power module are connected to each other with a relay.
